(19) United States
(12) Patent Application Publication
(10) Pub. No.: US 2018/0200139 A1
(43) Pub. Date: Jul. 19, 2018

(54) SOFT TISSUE MOBILIZATION INSTRUMENT

(71) Applicant: Carl R. Hanson, Medford, OR (US)

(72) Inventor: Carl R. Hanson, Medford, OR (US)

(21) Appl. No.: 15/406,709

(22) Filed: Jan. 14, 2017

(51) Int. Cl. A61H 7/00; A61H 1/00

(52) U.S. Cl. CPC A61H 7/003; A61H 2205/108; A61H 1/008

(57) ABSTRACT

A soft tissue manipulation instrument for use by a practitioner on the soft tissue of a person having a first section with an outer tissue engagement edge shaped to conform to the soft tissue being treated and a second gripping section interconnected at a 90 degree angle with the first section having an outer curved gripping surface for the hand of the practitioner using the instrument.

### BACKGROUND OF THE INVENTION

The present invention relates to hand held tools and in particular to an instrument for the mobilization and treatment of human body soft tissue.

Soft tissue therapy is performed on an athlete or similar active individual by a trainer or bodyworker. Typically, the soft tissue such as muscles, tendons, fascia or ligaments reacts or breaks down after strenuous exercise, overuse or training or as a result of an injury. During a recovery or healing process, this tissue often causes fibrous adhesions or scar tissue with limited flexibility that ultimately will affect the individual's use of the injured area thereby impacting performance or just the well-being of the person. Repair of these areas may be done using the hands and fingers of a practitioner trained in the art of physical, soft tissue therapy, including various massage and deep tissue massage as well as cross frictional massage and rolfing. Using hands-on techniques to manipulate and mobilize the soft tissue often results in difficulty in applying the appropriate amount of pressure to achieve the desired result. Too little pressure will result in insufficient healing and too much pressure can result in additional injury.

To overcome this shortcoming in the soft tissue healing arts, a wide variety of tools and instruments have been developed for use by healthcare practitioners, physical therapists, occupational therapists, chiropractors and massage therapists to treat areas of soft tissue restriction and degeneration. These tools are used to break down fascial restrictions, including fascial adhesions and scar tissue, allowing for the return of normal movement of the muscle, ligament, tendon and/or joints. This technique enhanced and supported by an assisted soft tissue mobilization instrument promotes healing by increasing blood flow to the area of restriction, which, in turn, promotes an increase of nutrients flowing into and waste products flowing out of the degenerated tissue area.

These prior art instruments are generally shaped to match the particular shape of the soft tissue being treated. These tools have various curved surfaces including round, arcuate and parabolic shaped soft tissue engaging surfaces that enable a practitioner to apply essentially even pressure across the particular area being treated to break-up and loosen the fibrous and other material sought to be eliminated.

Prior art patents and applications include U.S. Pat. No. 5,366,437 to Graston, U.S. Pat. No. 6,077,239 to Lin, U.S. Pat. No. D 696,414 to Hayami, U.S. Pat. No. D 686,333 to Innes, U.S. Pat. No. D 678,539 to Narson, U.S. Pat. No. D 645,568 to Walker, U.S. Pat. No. D 638,549 and U.S. Pat. No. D 634,022 to Scappaticci, and 2015/0265486 to Fiore.

Whereas the soft tissue engaging surfaces of these tools typically are well designed to engage the soft tissue, the overall shape of the tool is often awkward to handle requiring the practitioner to constantly grip and re-grip to tool in order to use it to maximum potential. Another shortcoming is that these tools usually require lubricant between the skin and the working edges of the tool. This results in difficulty handling the tool by the practitioner.

### SUMMARY OF THE INVENTION

The present invention relates to a soft tissue mobilization instrument having at least one soft tissue engaging surface or edge shaped and designed for precise and even engagement of the injured area. In addition, the instrument includes a gripping area disposed at an angle to facilitate gripping by the practitioner so to locate the working, soft tissue engagement surface in a precise and comfortable position so the soft tissue mobilization movements can be easily performed with essentially no manipulation of the instrument during the process. The angular gripping area is removed from the working edge where lubricant is normally applied thereby eliminating the gripping problems of the more conventional tools where the lubricant is adjacent the area that is gripped during use.

Structurally, a preferred instrument in accordance with the present invention is formed with two generally flat, planar sections connected along their respective inner longitudinal edges and arranged at an angle with respect to each section. Preferably the sections are attached at an angle of 90 degrees although it will be appreciated the attaching angle may be slightly altered while having the same structural advantages.

One of the sections that forms the gripping area has an outer edge that is curved and may be slightly concave or convex. The other section disposed at the 90 degree angle include an outer edge that engages the soft tissue of the individual being treated. Preferably this edge is formed with a pair of parabolic shapes closely located and having an opening therebetween whereby the tissue being treated can be positioned between the parabolic shapes to facilitate treatment.

The ninety degree angle instrument of the present invention provides a shape that allows for an improved grip for the practitioner, particularly when working in and around the curves and nooks of the body. A preferred instrument in accordance with the present invention is made of solid, heavy, polished metal such as stainless steel or the like thereby having significant weight that enhances the practitioner's ability to feel the depth of the soft tissue restrictions in the large fibrous areas of the body, such as the planter surface of the foot, IT band and the hamstring tendon.

The present invention includes various embodiments of the instrument whereby the gripping areas and the working areas may be altered and/or interchanged to fit particular body shapes such by altering the size and shape of the parabolic soft tissue engaging area, as well as the edge of the gripping section.

Among the objects of the present invention is the provision of a soft tissue mobilization instrument that is used by a health care practitioner to manipulate and mobilize the soft tissue of an individual.

Another object is the provision of a soft tissue mobilization instrument that is easy to hold by a practitioner during a treatment of the soft tissue of an individual.

Still another object is the provision of a soft tissue mobilization instrument that promotes healing in an area of restriction of the soft tissue of an individual by promoting blood flow in the soft tissue.

These and other objects will become apparent with reference to the following detailed description and accompanying drawings of the instrument of the present invention.

### DESCRIPTION OF THE DRAWINGS

FIG. 1 is a perspective view of a first embodiment of a soft tissue mobilization instrument of the present invention.

FIG. 2 is a top plan view of the instrument of FIG. 1.

FIG. 3 is a top plan view of the instrument of FIG. 1 rotated 90 degrees from FIG. 2.

FIG. 4 is an end view of the instrument of FIG.

FIG. 5 is a view of the instrument of FIGS. 1-4 used to treat the soft tissue of an individual.

FIG. 6 is a perspective view of a second embodiment of a soft tissue mobilization instrument of the present invention.

FIG. 7 is a top plan view of the instrument of FIG. 6.

FIG. 8 is a top plan view of the instrument of FIG. 6 rotated 90 degrees from FIG. 7.

FIG. 9 is an end view of the instrument of FIG. 6.

FIG. 10 is a view of the instrument of FIGS. 6-9 used to treat the soft tissue of an individual.

FIG. 11 is a view of the instrument of FIGS. 6-9 showing an alternate way to treat the soft tissue.

FIG. 12 is a perspective view of a third embodiment of a soft tissue mobilization instrument of the present invention.

FIG. 13 is a top plan view of the instrument of FIG. 12.

FIG. 14 is a top plan view of the instrument of FIG. 12 rotated 90 degrees from FIG. 13.

FIG. 15 is an end view of the instrument of FIG. 12.

FIG. 16 is a view of the instrument of FIGS. 12-15 used to treat the soft tissue of an individual.

### DESCRIPTION OF THE PREFERRED EMBODIMENTS

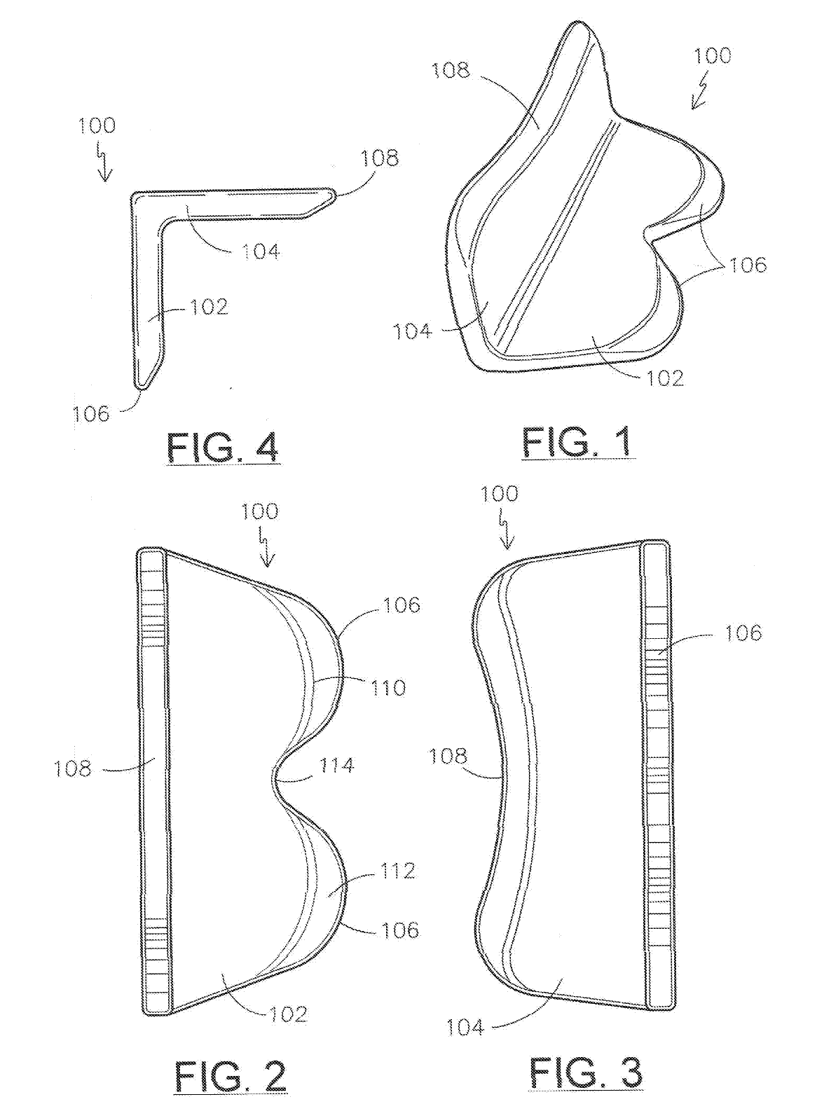

Referring to the drawings, a preferred embodiment of the soft tissue mobilization instrument 100 is illustrated in FIGS. 1 to 5. The instrument 100 has two generally flat, planar sections 102 and 104 connected along their respective inner longitudinal edges and arranged at an angle with respect to each section. A first section 102 has a pair of soft tissue engaging surfaces 106 or edges shaped and designed for precise and even engagement of an injured area of a person being treated. The second section 104 of the instrument 100 forms an edge gripping area 108 disposed preferably at a 90 degree angle with respect to the first section 102 to facilitate gripping by the practitioner so to locate the working, soft tissue engagement surfaces 106 in a precise and comfortable position so the soft tissue mobilization movements can be easily performed with essentially no manipulation of the instrument 100 during the process. It will be appreciated the attaching angle between the sections 102 and 104 may be slightly altered while having the same structural advantages described. The preferred 90 degree angle of the instrument 100 provides a shape that allows for an improved grip for the practitioner, particularly when working in and around the curves and nooks of the body.

The outer edge of the gripping area 108 is curved and in the present embodiment is convex. The soft tissue engaging surfaces 106 is formed as a pair of parabolic shaped members 110 and 112 closely located and having an opening 114 therebetween whereby the tissue being treated can be positioned between the parabolic shapes 110 and 112 to facilitate treatment.

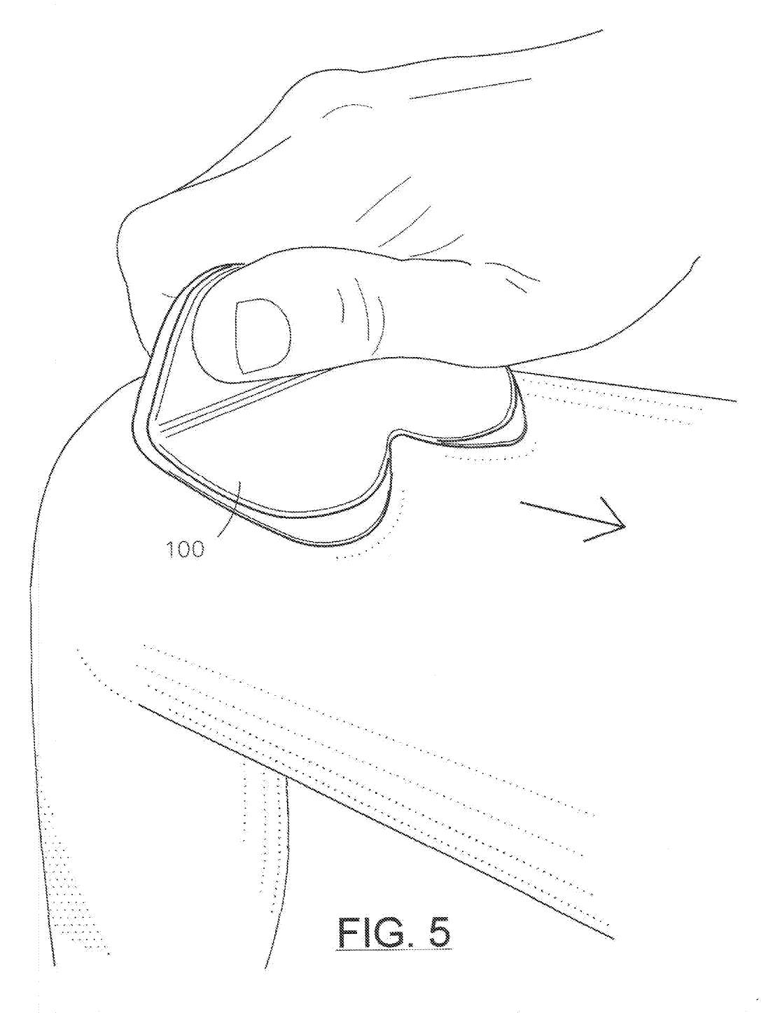

FIG. 5 illustrates the instrument 100 being used on the soft tissue of a leg of a person receiving treatment.

Although the size of the instrument 100 may vary depending upon the particular size and location of the person being treated, a conventional working embodiment of the instrument is approximately six inches long. The radius of the gripping edge 108 is 18 inches. The height of the parabolic members 112 and 114 is 1.5 inches and has a width of 3.0 inches at the base. The opening 116 between the parabolic members 110 and 112 is 2 inches at the top.

It will be appreciated that all the outer edges of the instrument 100 have a soft radius thereby eliminating sharp edges that may cause discomfort or injury to a person being treated. This also allows the instrument 100 to be used in a variety of different positions for easy access to specifically shaped areas of a person being treated.

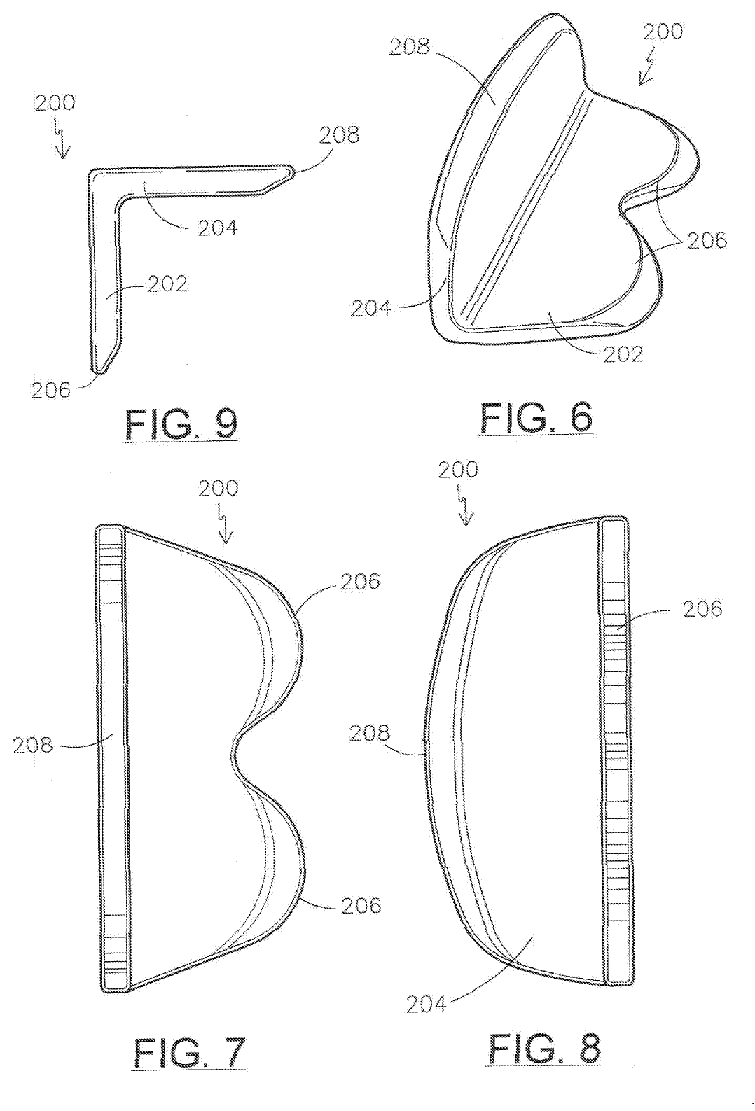

Referring to the drawings, another preferred embodiment of a soft tissue mobilization instrument 200 is illustrated in FIGS. 6 to 11. Similar to the first embodiment, the instrument 200 has two generally flat, planar sections 202 and 204 connected along their respective inner longitudinal edges and arranged at a 90 degree angle. The first section 202 has a pair of soft tissue engaging surfaces 206 or edges of the type illustrated in the first embodiment that are shaped and designed for precise and even engagement of an injured area of a person being treated. The second section 204 of the instrument 200 forms gripping area with a curved upper edge 208 to facilitate gripping by the practitioner.

This structure facilitates locating the working, soft tissue engagement surfaces 206 in a precise and comfortable position so the soft tissue mobilization movements can be easily performed with essentially no interruption of movement or manipulation of the instrument 200 during the process.

It will be appreciated the attaching angle between the sections 202 and 204 may be slightly altered while having the same structural advantages described. The preferred 90 degree angle of the instrument 200 provides a shape that allows for an improved grip for the practitioner, particularly when working in and around the curves and nooks of the body.

The outer edge 208 of the gripping area 204 is curved, and in this embodiment, is slightly concave. The soft tissue engaging surfaces 206 are formed as a pair of parabolic shaped members closely located and having an opening therebetween whereby the tissue being treated can be positioned between the parabolic shapes to facilitate treatment.

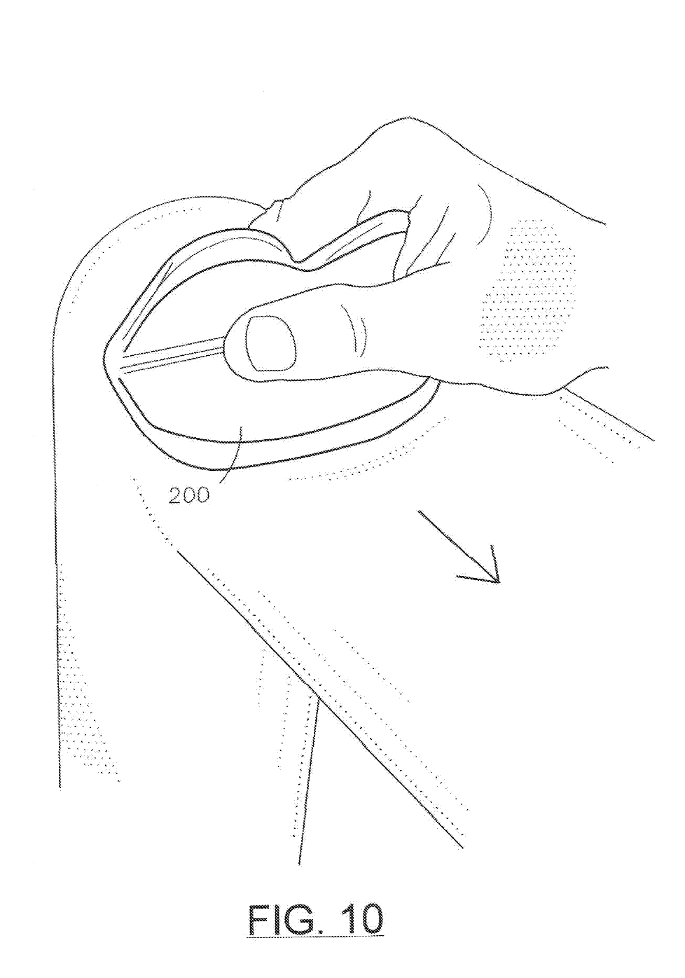

The instrument 200 is designed primarily to use the soft tissue engagement edge 206 to manipulate the tissue, it will be appreciated that all the edges of the instrument have radiuses that allow then to be used for various treatment purposes. For example, the convex, curved edge 208 of the gripping section 204 may also be used for tissue manipulation by simply reversing the grip on the instrument 200 as seen in FIG. 10.

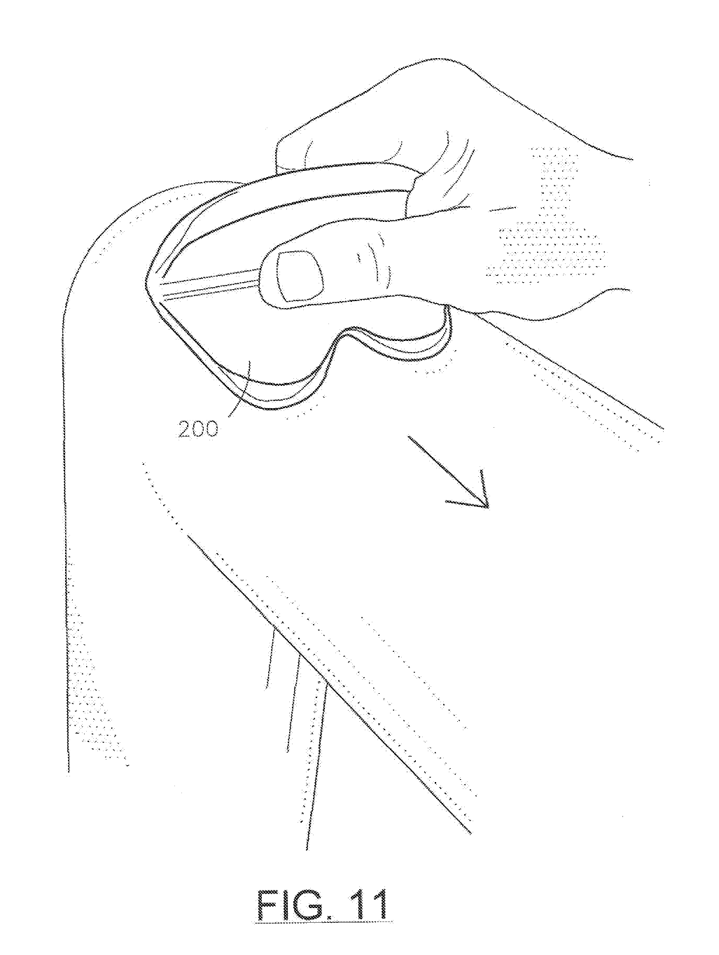

FIG. 11 illustrates the instrument 200 being used on the soft tissue of a leg of a person using surfaces 206.

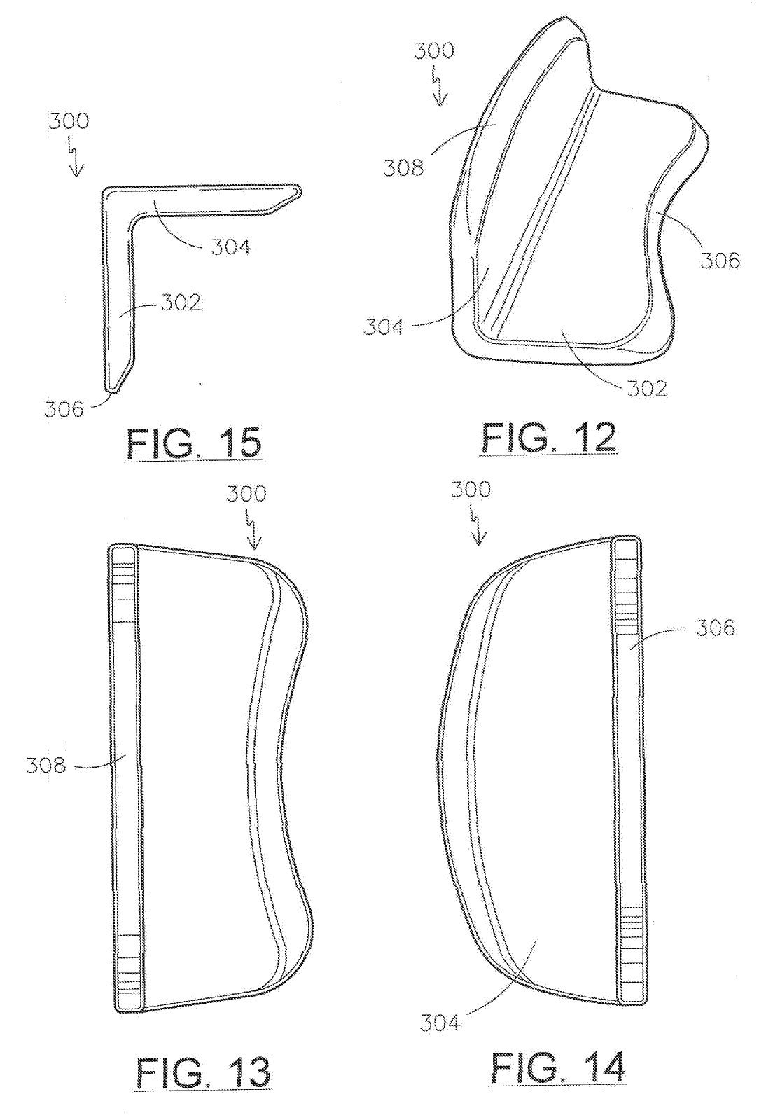

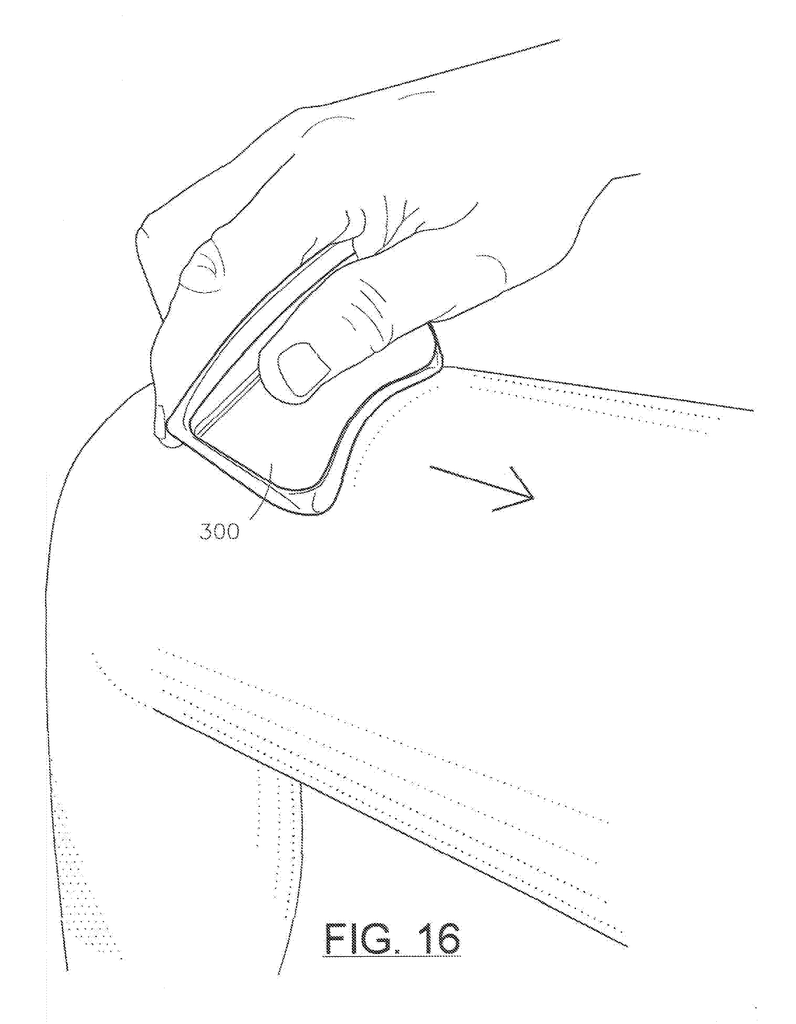

Referring to the drawings, another preferred embodiment of the soft tissue mobilization instrument 300 is illustrated in FIGS. 12 to 16. The instrument 300 has two generally flat, planar sections 302 and 304 connected along the respective inner longitudinal edges and arranged at an angle with respect to each section. A first section 302 has a soft tissue engaging surface 306 shaped and designed for precise and even engagement of an injured area of a person being treated. The second section 104 of the instrument 300 includes an edge gripping area 308 disposed preferably at a ninety degree angle to facilitate gripping by the practitioner so to locate the working, soft tissue engagement surface 306 in a precise and comfortable position so the soft tissue mobilization movements can be easily performed with essentially no manipulation of the instrument 300 during the process. It will be appreciated the attaching angle between the sections 302 and 304 may be slightly altered while having the same structural advantages described. The preferred 90y degree angle of the instrument 300 provides a shape that allows for an improved grip for the practitioner, particularly when working in and around the curves and nooks of the body.

The outer edge of the gripping area 304 is curved and may be slightly concave or convex. In this embodiment, it is shown convex. The single soft tissue engaging surface 306 is formed as an elongated parabolic, concave shape whereby the tissue being treated can be positioned on the member 306 to facilitate treatment.

FIG. 15 illustrates the instrument 300 being used on the soft tissue of a leg of a person receiving treatment.

Whereas the various preferred embodiments of the instruments hereinabove are designed primarily to use a specific soft tissue engagement edge to manipulate the tissue, it will be appreciated that all the edges of the instruments have radiuses that allow them to be used for various other treatment purposes. For example, the curved edge of a gripping section may also be used for tissue manipulation by simply reversing the grip on the instrument.

Similarly, all the edges of the instruments disclosed have soft radiuses that allow them to be used for various treatment purposes thereby eliminating sharp edges that may cause discomfort or injury to a person being treated. This also allows an instrument to be used at either of the ends for easy access to specifically shaped areas of a person being treated.

In all embodiments shown and described, instruments in accordance with the present invention are made of solid, heavy, polished metal such as stainless steel or the like thereby having significant weight that enhances the practitioner's ability to feel the depth of the soft tissue restrictions in the large fibrous areas of the body, such as the planter surface of the foot, IT band and the hamstring tendon.

It will be appreciated that various modifications may be made to the soft tissue mobilization instrument of the present invention in keeping within the spirit and scope of the following claims.

1. A manipulation instrument for use by a practitioner on the soft tissue of a person comprising:
a first section for engagement with soft tissue of the person being treated having an outer tissue engagement edge and a longitudinal inner edge; said first section being further defined by said outer tissue engagement edge being shaped to conform with the soft tissue of the person being treated;
a second section providing a gripping surface for the hand of the practitioner using the instrument having an outer gripping edge and a longitudinal inner edge;
said first and said second sections being characterized by being interconnected at an angle along said respective longitudinal inner edges of said first and said second sections.

2. The instrument of claim 1 wherein said angle between said interconnected first and second sections is 90 degrees.

3. The instrument of claim 1 wherein said outer gripping edge is curved.

4. The instrument of claim 3 wherein said curved outer gripping edge is convex.

5. The instrument of claim 3 wherein said curved outer gripping edge is concave.

6. The instrument of claim 1 wherein said outer tissue engagement edge is formed of multiple surfaces shaped to conform to the soft tissue being treated.

7. The instrument of claim 6 wherein said multiple surfaces are further defined as two parabolic shapes each having a base along said longitudinal inner edge and a curved upper edge; said parabolic shapes having an opening therebetween to accommodate the placement of soft tissue during a treatment process.

8. The instrument of claim 1 wherein all edges of the instrument are formed with a radius.

9. A manipulation instrument for use by a practitioner on the soft tissue of a person comprising:
a first section for engagement with soft tissue of the person being treated having an outer tissue engagement edge and a longitudinal inner edge;
a second section providing an outer curved gripping surface for the hand of the practitioner using the instrument having an outer gripping edge and a longitudinal inner edge;
said first and said second sections being characterized by being interconnected at a 90 degree angle along the respective longitudinal inner edges of said first and said second sections;
said first section being further defined by said outer engagement edge being formed of multiple parabolic surfaces shaped to conform to the soft tissue being treated.

10. The instrument of claim 9 wherein said curved outer gripping edge is convex.

11. The instrument of claim 9 wherein said curved outer gripping edge is concave.

12. The instrument of claim 9 wherein said parabolic shapes each having a base along said longitudinal inner edge and a curved upper edge; said parabolic shapes having an opening therebetween to accommodate the placement of soft tissue during a treatment process.

13. The instrument of claim 12 wherein said parabolic shapes are two in number and are located equidistant along the length of said first section.

14. The instrument of claim 9 wherein said sections are flat and planar in shape.

15. The instrument of claim 14 wherein all edges of the instrument are formed with a radius.

16. The instrument of claim 9 wherein said outer tissue engagement edge is curved.

17. The instrument of claim 16 wherein said outer tissue engagement edge is concave.
